(19) United States
(12) Patent Application Publication
(10) Pub. No.: US 2019/0368262 A1
(43) Pub. Date: Dec. 5, 2019

(54) Thermal Break Window Fenestration Formed of Steel

(71) Applicant: Andrew Juneau, Rancho Santa Fe, CA (US)

(72) Inventor: Andrew Juneau, Rancho Santa Fe, CA (US)

(21) Appl. No.: 16/000,776

(22) Filed: Jun. 5, 2018

(51) Int. Cl. E06B 3/267; E06B 3/12; E06B 3/58

(52) U.S. Cl. CPC E06B 3/267; E06B 2003/26398; E06B 3/5828; E06B 3/12

(57) ABSTRACT

A fenestration formed of flattened steel with special thermal break structures therein.

### BACKGROUND

It is important for a window to form insulation between its inside and outside. This is done by forming a thermal break between the surface of the window that faces the outside and the surface that faces the inside.

Steel windows and doors have conventionally have compromised thermal properties. Windows made of vinyl or wood have become more prevalent because of the improved thermal characteristics of those materials.

Steel windows can improve their insulating capabilities by using a thermal break. A conventional steel window uses a specially formed steel thermal break formed of a steel refractory shape to form a crimped section. This is expensive to form, and requires special tooling to make the window.

### SUMMARY OF THE INVENTION

The inventor recognized that it is desirable to use standard steel shapes that are common and can be purchased off the shelf, and configuring those materials to form a thermal break between the inside and outside of the fenestration.

The present application describes using standard off-the-shelf steel shapes formed of an outer steel frame, an inner steel frame, and a thermal break in between the outer steel frame and the inner steel frame. In an embodiment, there is a special thermal break formed by an insulating block, reinforced by a structural steel member.

### BRIEF DESCRIPTION OF THE DRAWINGS:

These and other aspects will now be described in detail with reference to the accompanying drawings, wherein:

FIG. 1 shows a front view of an exemplary window;

FIG. 2 shows a cross section of the frame to wall section of the window; and

FIG. 3 shows a cross section of the divided muntin section of the window.

### DETAILED DESCRIPTION

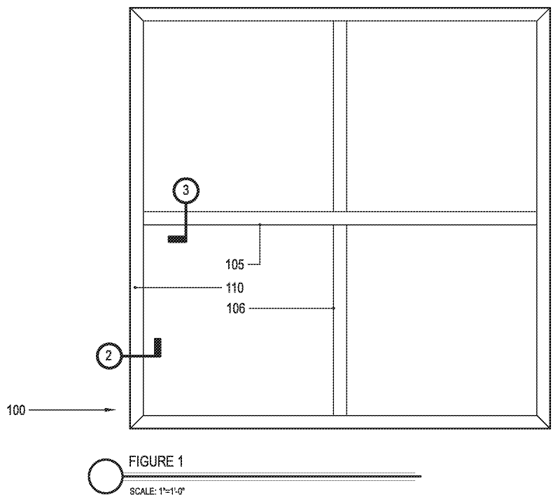

FIG. 1 shows an embodiment of a window according to the present application with a special built-in thermal break. It should be understood that the window is an embodiment, that the descriptions made herein apply to any fenestration, including a door or other.

Other windows which use steel windows use a special shaped steel frame, and crimp the thermal block between the parts of the steel frame. The inventor recognized that this is an extremely expensive way to form the window, since specially milled and shaped pieces need to be formed and this is very expensive. In addition, because the thermal break is crimped between the frames, any physical trauma, such as an earthquake, can compromise the structural integrity of the window and cause it to break.

As explained herein, the structure of the present application is much more strong and resistant to things like earthquakes. In an earthquake, the thermal break of the window described in the embodiment might crack; however the structural integrity of the window as a whole will remain intact as the thermal break is only in slight compression rather than being crimped in between steel parts.

FIGS. 1-3 show an embodiment which addresses all these issues. The embodiments describe a window; however, these features could be used for any Fenestration or opening in a building, including a window, door, vent, or any other opening. FIG. 1 illustrates a window elevation of the window 100 according to an embodiment. The window in this embodiment is a 4′×4′ window although other sizes can be used. There is a window separator part 105, 106, or “muntin”, which divides the windows into 4 sections of approximately 2′×2′. The window is also surrounded by an edge frame 110. Further details on the structures of the edge frame and the separator frame are provided herein.

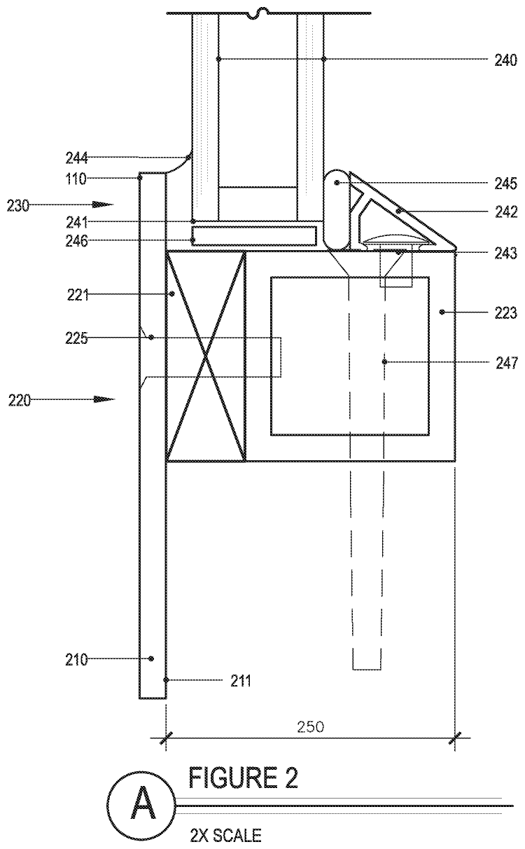

FIG. 2 illustrates a cross section of the edge frame 110. A structural steel bar 210 extends from a first end 211 pressed against the framing, to a thermal break area 220, and up to the window glass adjoining area 230, where the steel bar adjoins and abuts against the outside of the window glass 240. This bottom vertical fin is optional. In one embodiment, the steel bar can be a 2½ inch wide steel bar of size 11 gauge.

The thermal break section 220 forms an area that creates a heat break or thermal break between the framing, and the glass. A first structural part of the thermal break is a block 221 of thermal break material such as PVC. In this embodiment, the PVC block is a ⅜ by ¾ inch block that extends all the way along the exterior of the window. The PVC thermal break adjoins against a tube steel member 223 which abuts against the PVC thermal break and forms a structural component using standard tube steel. The tube steel also extends around the complete perimeter of the window.

In one embodiment, the tube steel can be 0.75×1″ by #11 gauge tube steel extending all the way around the window, while the PVC thermal block similarly extends all the way around the window. The overall structure including the steel plate 210, the PVC thermal block 221 and the tube steel structure 223 are held together with a rivet 225 which in one embodiment can be a blind rivet.

The glass section 240 is held a top surface of the thermal break formed by the PVC structure 221 and the tube steel 223, so that the bottom surface 241 of the glass section 240 is seated on a setting block 246 which is directly on the thermal break structure. The window glass 240 is also held between two structural members: the structural plate 210 and a glazing bead 242 which is attached by a screw 243 to the tube steel structure 223, or can be wet-glazed into place utilizing glazing putty.

The tube steel can be attached by a screw 247 into the building framing 250, thus holding the structural tube steel firmly into the framing 250.

Glazing material 244, 245 either glazing putty or glazing tape is located between the window glass 240 and the structural members. Glazing putty 244 is between the window and the structural steel 210; and glazing tape 245 is between the window and the glazing bead 242 which is held to the tube steel, to hold the window glass into place. In this way, there is a complete thermal break between the exterior and interior of the building.

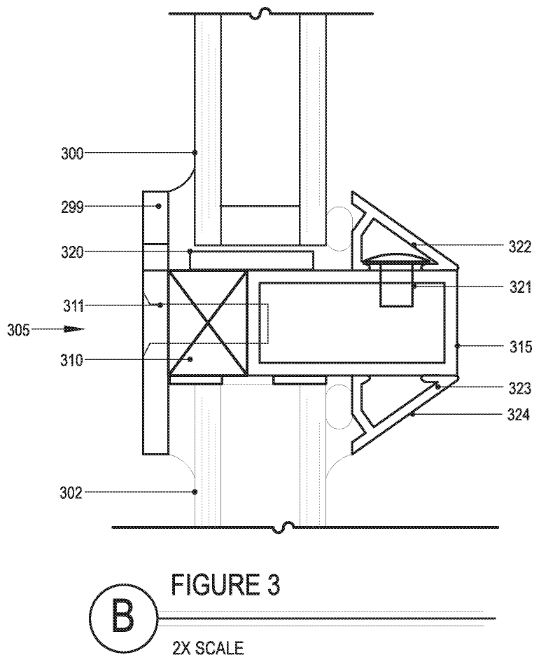

A second thermal break is formed by the muntins that separate panes in the window. A detail of the muntins 105 and 106 is shown along the cross-section along the line 3-3 in FIG. 3. This shows how the muntin 305 separates the first glass pane 300 from the second glass pane 302 in the window for a true divided thermally broken lite. Each muntin itself is formed of a thermal break structure 310 which in an embodiment can be a ⅜ inch by ½ inch PVC thermal break attached by adhesive to other structures. A tube steel part of the thermal break is shown as 315. This can be a 0.5″×1″×16 gauge tube steel structure. A setting block 320 is located on top of the tube steel structure 315, and held by a glazing bead 322, screwed in to the tube steel piece by a screw 321. Glazing beads hold the window glass 300 to the respective parts. The tube steel is 315 is held to the bulk thermal break 310 by a rivet 311. This forms a thermal break between the two adjoining sections of glass. In operation, the glass is held between the glazing bead 322 on the top and the structural steel 299. On the bottom, the glass is held between the structural steel 299 and the glazing bead 323. Glazing putty or glazing beads 324 can hold the glass between the structural elements.

In this way, a very simple structure can be used to form a thermal break which requires only flat and bent steel pieces, and does not require any specialty pieces at all. The glass is held between two flat surfaces by glazing beads or glazing putty, and the two flat surfaces are held to a two part thermal break, one of which is thermally insulating, and the other of which is a piece of tube steel which provides structural integrity for the thermal break.

Even though this is a simple system, applicant has simulated the U factor of 0.287, in spite of the fact that this system provides significant structural integrity factor.

While the preferred embodiments have been shown and described, it will be understood that there is no intent to limit the invention by such disclosure, but rather, is intended to cover all modifications and alternate constructions falling within the spirit and scope of the invention.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments, which might be predictable to a person having ordinary skill in the art. For example, other sizes of material could be used, and while this describes use of one certain thermal break material as being PVC, other thermal break materials which are structural could also be used. Other devices can be held between the surfaces.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A fenestration system with a thermal break comprising:
a first thermal break system, forming an edge perimeter of the fenestration, formed of a solid block of thermal break material adjoining on one side a length of tube steel and on the other side a structural metal;
a structural connector, connecting between said structural metal, said solid block of thermal break material and said length of tube steel to form a structurally combined thermal break assembly;
where the structurally combined thermal break assembly extends all the way around a perimeter of the fenestration, and includes a first inside surface for holding fenestration glass, and a second outside surface for connecting to structural framing,
where both the inside surface and the outside surface each have a flat area formed by the block of solid block of thermal break material and a surface of the tube steel,
and where the outside surface adjoins and connects to a framing piece, and where the inside surface forms a flat surface on which the fenestration glass is attached and where the fenestration glass is held between the structural metal and another metal piece attached to the structurally combined thermal break assembly.

2. The system as in claim 1, wherein the structurally combined thermal break assembly is attached by driving a fastener through the inside surface of the tube steel to the framing.

3. The system as in claim 1 wherein said another metal piece is a setting block, attached to the inside surface of the tube steel, said setting block having a first surface attached to the tube steel, and a second surface perpendicular to the first surface, the second surface forming a glass holding surface against which the glass is held on one side, being held on the other side by the structural steel.

4. The system as in claim 3, further comprising glazing beads, holding the glass between the structural steel on one side and the glass at the other side.

5. The system as in claim 1, where the thermal break material is a solid block of PVC material.

6. The system as in claim 1, further comprising a muntin in a middle section of the fenestration, separating multiple pieces of glass in the fenestration from one another, said muntin having a thermal break therein.

7. The system as in claim 1, where said structural metal is a flat length of steel.
